(19) United States
(12) Patent Application Publication
(10) Pub. No.: US 2025/0321124 A1
(43) Pub. Date: Oct. 16, 2025

(54) Inductive Sensor Arrangement for Detecting the Movement of a Movable Body

(71) Applicant: Robert Bosch GmbH, Stuttgart (DE)

(72) Inventors: Andre Yashan, Stuttgart (DE); Christian Karcher, Buehl (DE); Debora Pereira, Porto (PT); Robert Alexander Dauth, Heilbronn (DE); Sina Fella, Neuenstadt (DE); Stefan Kuntz, Flein (DE); Tim Krzyzanowski, Lauffen Am Neckar (DE); Ville Kivijarvi, Helsinki (FI)

(21) Appl. No.: 19/174,300

(22) Filed: Apr. 9, 2025

(30) Foreign Application Priority Data
Apr. 11, 2024 (DE) 10 2024 203 299.9

(51) Int. Cl. G01D 5/20; G01B 7/30

(52) U.S. Cl. CPC G01D 5/20; G01B 7/30

(57) ABSTRACT

An inductive sensor arrangement for detecting a movement of a movable body is disclosed. The inductive sensor arrangement has a measured value acquisition device which includes an exciter structure and a receiver structure, and a coupling device. An evaluation and control unit is designed to couple a periodic alternating signal into the exciter structure during operation and to evaluate signals induced in the receiver structure and to determine a measurement signal. The coupling device has a base body with at least one electrically conductive coupling segment and is designed to influence an inductive coupling between the exciter structure and the receiver structure. An overlap ratio, which is calculated from an overlap dimension of the electrically conductive coupling segment in the direction of movement with respect to a periodic section of the receiver structure, is selected as a function of a resulting measurement error and a resulting amplitude of the measurement signal such that the resulting measurement error of the measurement signal falls below a predetermined first threshold value which is present at a coverage ratio of 0.5, and the resulting amplitude exceeds a predetermined design-dependent second threshold value.

This application claims priority under 35 U.S.C. § 119 to application no. DE 10 2024 203 299.9, filed on Apr. 11, 2024 in Germany, the disclosure of which is incorporated herein by reference in its entirety.

### BACKGROUND

The disclosure relates to an inductive sensor arrangement for detecting the movement of a movable body.

Inductive sensor arrangements are known from the prior art, which are used as a rotary movement sensor for detecting a rotary movement or as a linear position sensor for detecting a linear movement. Such an inductive sensor arrangement comprises a measured value acquisition device with at least one exciter structure and at least one receiver structure and at least one coupling device, which is also referred to as a target. In this case, the measured value acquisition device or the at least one coupling device is coupled to the movable body. The at least one exciter structure further comprises at least one exciter coil. The at least one coupling device comprises at least one electrically conductive coupling segment. The at least one receiver structure comprises at least one, but usually two, receiving coils. A high frequency current passes through the at least one exciter coil generating an alternating magnetic field, which induces eddy currents in the at least one coupling device. In this context, the inductive coupling of the at least one exciter coil and the at least one receiving coil depends on the position of the corresponding coupling device. The induced voltage signal in the at least one receiver coil can be used to infer the current position of the coupling device and thus the current position of a body whose movement is to be detected.

### SUMMARY

The inductive sensor arrangement for detecting a movement of a movable body with the features set forth below has the advantage that, by selecting an overlap ratio, which is calculated from an overlap dimension of the at least one electrically conductive coupling segment in the direction of movement with respect to a periodic section of the at least one receiver structure, the smallest possible measurement error of the measurement signal and the largest possible amplitude of the measurement signal can be set. As a result, an amplitude of a voltage induced in the at least one receiver structure and of the resulting measurement signal can be increased by embodiments of the inductive sensor arrangement according to the disclosure and, at the same time, a measurement error of the measured value acquisition device or of the inductive sensor arrangement can be reduced. This means, for example, that angle errors can be reduced when measuring a rotary movement and distance errors when measuring linear movements. Smaller measurement errors allow for a smaller installation space and eliminate the need for a harmonic correction. The larger amplitude of the measurement signal results in a better signal-to-noise ratio and better EMC robustness (EMC: electromagnetic compatibility). In addition, the larger amplitude of the measurement signal allows for larger air gaps and thus cost savings in the mechanical system. Furthermore, the larger amplitude of the measurement signal allows for the use of less expensive semiconductor amplifiers with lower amplification factors.

Embodiments of the present disclosure provide an inductive sensor arrangement for detecting a movement of a movable body, with at least one measured value acquisition device, which comprises at least one exciter structure and at least one receiver structure, and at least one coupling device. In this case, the at least one measured value acquisition device or the at least one coupling device is coupled to the movable body. At least one evaluation and control unit is designed to couple a periodic alternating signal into the at least one exciter structure during operation and to evaluate signals induced in the at least one receiver structure and to determine a measurement signal for a current position of the movable body. The at least one coupling device has a base body with at least one electrically conductive coupling segment and is designed to influence an inductive coupling between the at least one exciter structure and the at least one receiver structure. In this case, an overlap ratio, which is calculated from an overlap dimension of the at least one electrically conductive coupling segment in the direction of movement with respect to a periodic section of the at least one receiver structure, is selected as a function of a resulting measurement error and a resulting amplitude of the measurement signal such that the resulting measurement error of the measurement signal falls below a predetermined first threshold value, which is present at a coverage ratio of 0.5, and the resulting amplitude exceeds a predetermined design-dependent second threshold value.

The inductive sensor arrangement can, for example, be designed as a rotary position sensor or rotor position sensor, in which the movable body performs a rotary movement about an axis of rotation. Alternatively, the inductive sensor arrangement can be designed as a linear path sensor in which the movable body performs linear movement intended to be acquired.

In the present case, an evaluation and control unit can be understood as an electrical assembly or electrical circuit that prepares, processes or evaluates recorded sensor signals. Preferably, the evaluation and control unit can be designed as an ASIC component (ASIC: application-specific integrated circuit). The evaluation and control unit can comprise at least one interface, which can be implemented as hardware and/or software. When implemented as hardware, the interfaces can be part of the ASIC component, for example. However, it is also possible that the interfaces are dedicated integrated circuits or consist at least partly of discrete components. When implemented as software, the interfaces can be software modules present, for example, on a microcontroller alongside other software modules.

The exciter structure can be understood as an exciter coil with a predetermined number of windings, which emits the alternating signal coupled in by the at least one oscillator circuit.

The measures and further developments set forth below enable advantageous improvements to the inductive sensor arrangement specified herein.

It is particularly advantageous that the at least one receiver structure can comprise at least one receiving coil with at least one winding, which has two periodically repeating loop structures. In this case, the two loop structures of the individual windings are arranged offset by 180 degrees to one another. This enables a particularly cost-effective and simple realization of the at least one receiver structure. In this case, the periodic section of the at least one receiver structure can correspond to a complete period of the periodically repeating loop structures of the at least one receiving coil. Preferably, the at least one receiver structure can have two receiving coils that are arranged offset with respect to one each other at 90 degrees, so that a first receiving coil can form a sine channel and a second receiving coil can form a cosine channel. Also, the at least one evaluation and control unit can be designed to determine the measurement signal from a sine channel signal and from a cosine channel signal using an arctangent function. Alternatively, the receiver structure may comprise three receiving coils having a periodically repeating loop structure forming a multi-phase system. The at least one evaluation and control unit may be designed to carry out a suitable phase transformation of signals of the multi-phase system, and to determine the measurement signal using an arctangent function. For example, signals of a three-phase system may be transformed into two signals by way of a Clarke transformation, from which the measurement signal may then be determined by way of the arctangent function.

In a further advantageous embodiment of the inductive sensor arrangement, the overlap ratio can be selected from a range of 0.7 to 0.8, preferably from a range of 0.7 to 0.75. In particular, the range of 0.7 to 0.75 can combine the advantages of low measurement error and high amplitude of the induced voltage and the corresponding measurement signal. Typically, the amplitude of the induced voltage can decrease again at a larger overlap ratio than 0.75, while the measurement error can also increase. As a result, the overlap ratio is no longer advantageous, particularly in a range of more than 0.8. Below an overlap ratio of less than 0.7, the angle error can typically increase and the amplitude of the induced voltage can decrease. In particular, the overlap ratio is no longer advantageous in a range smaller than 0.6. With an overlap ratio in the range of 0.3 to 0.4, there may be a further local minimum of the design-dependent measurement error. However, the amplitude of the induced voltage is significantly lower here than in the range between 0.7 and 0.8.

In a further advantageous embodiment of the inductive sensor arrangement, the overlap ratio and/or the design-dependent second threshold value of the resulting amplitude of the measurement signal can be predetermined as a function of an air gap between the at least one coupling device and the at least one receiver structure and/or of a periodicity of the at least one receiver structure and/or of a geometry of the at least one receiver structure. This makes it possible to conveniently specify the overlap ratio and/or the second threshold value as a function of the mechanical design of the inductive sensor arrangement.

In a further advantageous embodiment of the inductive sensor arrangement, the two loop structures of the at least one winding of the at least one receiving coil can each have a plurality of loop sections and be formed in at least two planes of a circuit carrier and have opposite flow directions. In this case, sections of the individual loop structures arranged in different planes of the circuit carrier can be electrically connected to each other via through-hole platings.

In a further advantageous embodiment of the inductive sensor arrangement, the movable body can perform a rotary movement about an axis of rotation, in which the measurement error corresponds to an angle error. To detect the rotary movement of the movable body about an axis of rotation, the at least one coupling device can have a base body designed as a rotor. In this case, the at least one electrically conductive coupling segment can be designed as a wing and connected to the base body designed as a rotor. In this embodiment of the at least one coupling device, the overlap dimension of the at least one electrically conductive coupling segment in the direction of movement can correspond to an arc or a circular ring segment.

Alternatively, the movable body can perform a linear movement, in which the measurement error corresponds to a distance error. To detect the linear movement of the movable body, the at least one coupling device can have a base body designed as a carrier. In this case, the at least one electrically conductive coupling segment can be designed as a surface and arranged on the base body designed as a carrier. In this embodiment of the at least one coupling device, the overlap dimension of the at least one electrically conductive coupling segment in the direction of movement can correspond to a straight line or a rectangle.

Exemplary embodiments of the disclosure are illustrated in the drawings and explained in more detail in the following description. In the drawings, identical reference numerals refer to components or elements performing identical or similar functions.

### BRIEF DESCRIPTION OF THE DRAWINGS

FIG. 1 shows a schematic illustration of a first exemplary embodiment of an inductive sensor arrangement for detecting a movement of a movable body, according to the disclosure.

FIG. 2 shows a schematic plan view of the inductive sensor arrangement according to the disclosure from FIG. 1 with a coupling device shown in a transparent manner.

FIG. 3 shows a schematic plan view of a second exemplary embodiment of an inductive sensor arrangement according to the disclosure with a coupling device shown in a transparent manner.

FIG. 4 shows a schematic characteristic curve diagram with two characteristic curves, each of which represents a measurement error overlap ratio curve of the inductive sensor arrangement according to the disclosure, and a characteristic curve which represents an amplitude overlap ratio curve of the inductive sensor arrangement according to the disclosure.

### DETAILED DESCRIPTION

As shown in FIGS. 1 to 3, the exemplary embodiments of an inductive sensor arrangement 1 for detecting a movement of a movable body 3 according to the disclosure each comprise at least one measured value acquisition device 10, which comprises at least one exciter structure 14 and at least one receiver structure 16, and at least one coupling device 20. In this case, the at least one measured value acquisition device 10 or the at least one coupling device 20 is coupled to the movable body 3. In addition, at least one evaluation and control unit 5 is designed to couple a periodic alternating signal into the at least one exciter structure 14 during operation and to evaluate signals induced in the at least one receiver structure 16 and to determine a measurement signal MS for a current position of the movable body 3. The at least one coupling device 20 has a base body 22 with at least one electrically conductive coupling segment 24 and is designed to influence an inductive coupling between the at least one exciter structure 14 and the at least one receiver structure 16. An overlap ratio UV, which is calculated from an overlap dimension UB of the at least one electrically conductive coupling segment 24 in the direction of movement BR, with respect to a periodic section PA of the at least one receiver structure 16, is selected as a function of a resulting measurement error MF and a resulting amplitude AM of the measurement signal MS such that the resulting measurement error MF of the measurement signal MS falls below a predetermined first threshold value SW1, which is present at an overlap ratio UV of 0.5, and the resulting amplitude AM exceeds a predetermined design-dependent second threshold value SW2.

In the exemplary embodiments of the inductive sensor arrangement 1, the evaluation and control unit 5 outputs the measurement signal to a higher-level control device 7, which evaluates the measurement signal to control corresponding vehicle functions.

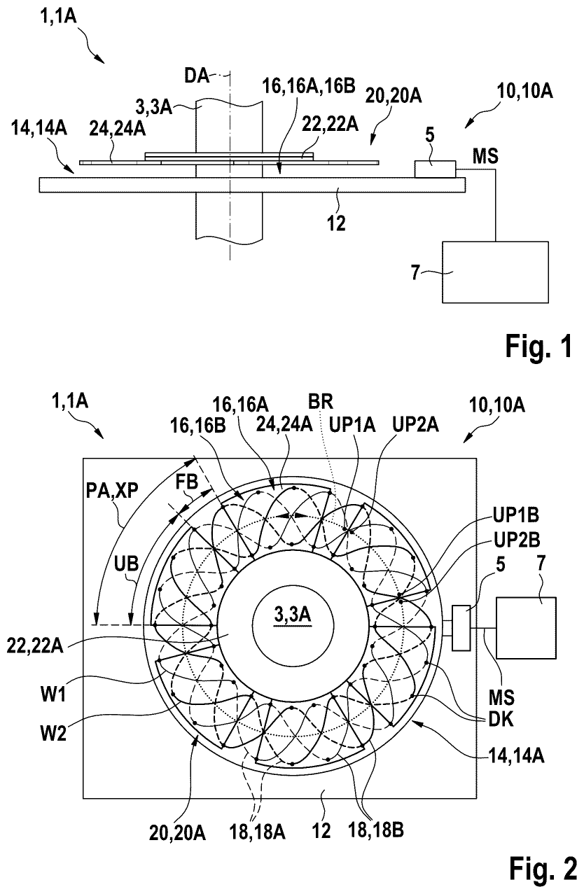

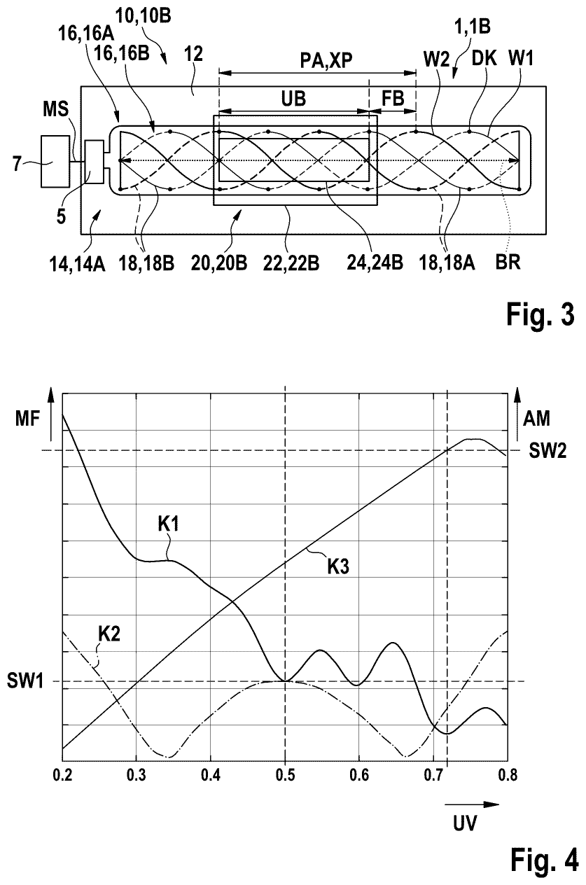

As can be seen in particular from FIGS. 2 and 3, the exemplary embodiments of the inductive sensor arrangement 1 shown each comprise a circuit carrier 12 having an exciter structure 14, which in the exemplary embodiments of the inductive sensor arrangement 1 shown comprises an exciter coil 14A having windings arranged in two planes of the circuit carrier 12, and a receiver structure 16, which comprises two receiving coils 16A, 16B with a winding W1, W2. The individual windings W1, W2 of the two receiving coils 16A, 16B each have two periodically repeating loop structures 18A, 18B. The two loop structures 18A, 18B of the individual windings W1, W2 are arranged offset by 180 degrees to one each other.

As can be seen from FIGS. 2 and 3, the two loop structures 18A, 18B of the individual windings W1, W2 of the two receiving coils 16A, 16B each have several loop sections which are formed in at least two planes of the circuit carrier 12 and have opposite flow directions. Sections of the individual loop structures 18A, 18B arranged in different planes of the circuit carrier 12 are electrically connected to each other via through-hole platings DK. In addition, the periodic section PA of the illustrated receiver structures 16 corresponds in each case to a complete period XP of the periodically repeating loop structures 18A, 18B of the two receiving coils 16A, 16B.

As can be seen in FIG. 4, the illustrated characteristic curve diagram shows two characteristic curves K1, K2, which each exemplify the progression of the measurement error MF of the measurement signal MS as a function of the overlap ratio UV, and a third characteristic curve K3, which exemplifies the progression of the amplitude AM of the measurement signal MS as a function of the overlap ratio UV.

As can be seen further from FIG. 4, the first threshold value SW1 for the measurement error MF corresponds to the value of the measurement error MF at an overlap ratio of 0.5. In embodiments of the inductive sensor arrangement 1, the overlap ratio UV is selected from a range of 0.7 to 0.8. In particular, the range of 0.7 to 0.75 combines the advantages of a low measurement error MF and a high amplitude AM of the induced voltage or of the corresponding measurement signal MS.

As can be seen from FIG. 4, the amplitude of the induced voltage or the measurement signal MS continues to increase with a larger overlap ratio UV than 0.72, while the measurement error MF continues to increase significantly, especially for the design represented by the second characteristic curve K2. As a result, the overlap ratio UV is no longer advantageous in a range greater than 0.8, particularly for the design represented by the second characteristic curve K2. Below an overlap ratio of less than 0.7, the angle error can increase, particularly for the design represented by the first characteristic curve K1, and the amplitude AM of the induced voltage or measurement signal MS can decrease. As a result, the overlap ratio UV in a region smaller than 0.6 is no longer advantageous, especially for the design represented by the first characteristic curve K1. For an overlap ratio UV in the range from 0.3 to 0.4, there may be a further local minimum of the measurement error MS due to the design, especially for the design represented by the second characteristic curve K2. However, the amplitude AM of the induced voltage or measurement signal MS is significantly lower here than in the region between 0.7 and 0.8.

The overlap ratio UV and/or the design-dependent second threshold value SW2 of the resulting amplitude AM of the measurement signal MS is predetermined as a function of an air gap between the at least one coupling device 20 and the at least one receiver structure 16 and/or of a periodicity of the at least one receiver structure 16 and/or of a geometry of the at least one receiver structure 16. In the exemplary embodiments shown, the predetermined overlap ratio UV has a value of 0.72 in each case.

As can be seen from FIGS. 1 and 2, the first exemplary embodiment of the inductive sensor arrangement 1 is designed as a rotary movement sensor 1A. Therefore, the movable body 3 executes a rotary movement about an axis of rotation DA, in which the measurement error MF corresponds to an angle error.

As can be seen from FIGS. 1 and 2, the coupling device 20A in the exemplary embodiment of the rotary movement sensor 1A has a base body 22 designed as a rotor 22A, since the movable body 3 performs the rotary movement about an axis of rotation DA. In this case, the at least one electrically conductive coupling segment 24 is designed as a wing 24A and is connected to the base body 22 designed as a rotor 22A. This means that in the exemplary embodiment of the rotary movement sensor 1A, the overlap dimension UB of the electrically conductive coupling segment 24 in the direction of movement BR corresponds to a circular ring segment which covers only a part of the periodic section PA of the illustrated receiver structure 16 or of the complete period XP of the periodically repeating loop structures 18A, 18B of the two receiving coils 16A, 16B in the direction of movement BR and leaves an uncovered free section FB in the direction of movement BR. In the exemplary embodiment shown, the entire wing 24A forms the circular ring segment. In an alternative exemplary embodiment, not shown, of a rotary movement sensor 1A, the overlap dimension UB of the electrically conductive coupling segment 24 in the direction of movement BR can only overlap part of the wing 24A. In the extreme case, the overlap dimension UB of the electrically conductive coupling segment 24 in the direction of movement BR can correspond to only one arc applied to the wing 24A.

As can be seen from FIG. 3, the exemplary embodiment of the inductive sensor arrangement 1 is designed as a linear position sensor 1B. Therefore, the movable body, which is not described in more detail here, performs a linear movement in which the measurement error MF corresponds to a distance error.

As can be seen from FIG. 3, the coupling device 20B in the exemplary embodiment of the linear distance sensor 1B has a base body 22 designed as a carrier 22B, since the movable body 3 performs a linear movement. In this case, the at least one electrically conductive coupling segment 24 is designed as a surface 24B and arranged on the base body 22 designed as a carrier 22B. This means that in the exemplary embodiment of the linear distance sensor 1B shown, the overlap dimension UB of the electrically conductive coupling segment 24 in the direction of movement BR corresponds to a rectangular surface 24B, which covers only part of the periodic section PA of the illustrated receiver structure 16 or of the complete period XP of the periodically repeating loop structures 18A, 18B of the two receiving coils 16A, 16B in the direction of movement BR and leaves an uncovered free section FB in the direction of movement BR. In the exemplary embodiment shown, the rectangular surface 24B covers part of the carrier 22B. In an alternative exemplary embodiment of a linear distance sensor 1B, which is not shown, the overlap dimension UB of the electrically conductive coupling segment 24 in the direction of movement BR can cover a larger or smaller part of the carrier 22B. In the extreme case, the overlap dimension UB of the electrically conductive coupling segment 24 in the direction of movement BR can correspond to only one straight line on the carrier 22B.

What is claimed:

1. An inductive sensor arrangement for detecting a movement of a movable body, having at least one measured value acquisition device, which comprises at least one exciter structure, at least one receiver structure, and at least one coupling device, wherein:
the at least one measured value acquisition device or the at least one coupling device is coupled to the movable body,
at least one evaluation and control unit is designed to couple a periodic alternating signal into the at least one exciter structure during operation and to evaluate signals induced in the at least one receiver structure and to determine a measurement signal for a current position of the movable body,
the at least one coupling device has a base body with at least one electrically conductive coupling segment and is designed to influence an inductive coupling between the at least one exciter structure and the at least one receiver structure, and
an overlap ratio, which is calculated from an overlap dimension of the at least one electrically conductive coupling segment in the direction of movement with respect to a periodic section of the at least one receiver structure, is selected as a function of a resulting measurement error and a resulting amplitude of the measurement signal such that the resulting measurement error of the measurement signal falls below a predetermined first threshold value, which is present at an overlap ratio of 0.5, and the resulting amplitude exceeds a predetermined design-dependent second threshold value.

2. The inductive sensor arrangement according to claim 1, wherein the at least one receiver structure comprises at least one receiving coil having at least one winding which has two periodically repeating loop structures.

3. The inductive sensor arrangement according to claim 2, wherein the periodic section of the at least one receiver structure corresponds to a complete period of the periodically repeating loop structures of the at least one receiving coil.

4. The inductive sensor arrangement according to claim 1, wherein the overlap ratio is selected from a range of 0.7 to 0.8.

5. The inductive sensor arrangement according to claim 1, wherein the overlap ratio and/or the design-dependent second threshold value of the resulting amplitude of the measurement signal is predetermined as a function of an air gap between the at least one coupling device and the at least one receiver structure and/or of a periodicity of the at least one receiver structure and/or of a geometry of the at least one receiver structure.

6. The inductive sensor arrangement according to claim 2, wherein the two loop structures of the at least one winding of the at least one receiving coil each have a plurality of loop sections and are formed in at least two planes of a circuit carrier and have opposite flow directions.

7. The inductive sensor arrangement according to claim 6, wherein sections of the individual loop structures arranged in different planes of the circuit carrier are electrically connected to each other via through-hole plating.

8. The inductive sensor arrangement according to claim 1, wherein the movable body executes a rotary movement about an axis of rotation, in which the measurement error corresponds to an angle error, or executes a linear movement, in which the measurement error corresponds to a distance error.

9. The inductive sensor arrangement according to claim 8, wherein the at least one coupling device has a base body designed as a rotor when the movable body performs the rotary movement about an axis of rotation.

10. The inductive sensor arrangement according to claim 9, wherein the at least one electrically conductive coupling segment is designed as a wing and is connected to the base body designed as a rotor.

11. The inductive sensor arrangement according to claim 9, wherein the at least one coupling device has a base body designed as a carrier when the movable body executes a linear movement.

12. The inductive sensor arrangement according to claim 11, wherein the at least one electrically conductive coupling segment is designed as a surface and is arranged on the base body designed as a carrier.

13. The inductive sensor arrangement according to claim 1, wherein the overlap ratio is selected from a range of 0.7 to 0.75.
